(19) United States
(12) Patent Application Publication
(10) Pub. No.: US 2014/0279033 A1
(43) Pub. Date: Sep. 18, 2014

(54) REAL-TIME INTERACTIVE DIGITAL ADVERTISING SYSTEM AND METHOD OVER MOBILE WEB MESSAGING SERVICE

(71) Applicant: Jobaline, Inc., Kirkland, WA (US)

(72) Inventors: Miki Mullor, Sammamish, WA (US); Luis J. Salazar G., Kirkland, WA (US)

(73) Assignee: Jobaline, Inc., Kirkland, WA (US)

(21) Appl. No.: 14/215,218

(22) Filed: Mar. 17, 2014

Related U.S. Application Data
(60) Provisional application No. 61/792,597, filed on Mar. 15, 2013.
(60) Provisional application No. 61/793,096, filed on Mar. 15, 2013.
(60) Provisional application No. 61/792,969, filed on Mar. 15, 2013.
(60) Provisional application No. 61/792,418, filed on Mar. 15, 2013.
(60) Provisional application No. 61/792,646, filed on Mar. 15, 2013.

(51) Int. Cl. G06Q 30/02

(52) U.S. Cl. CPC G06Q 30/0267
USPC 705/14.64

(57) ABSTRACT

An interactive digital advertising system and method may include an advertising component for generating qualified leads in response to a lead request using interactive advertising units. The advertising system may provide “real-time” matching of leads, which may be validated based on a criteria defined by the lead requestor, to the services or products offered by the lead requestor. The interactive advertising units may communicate with leads over mobile messaging services, such as short message service (SMS), instant messaging (IM) service, or the like. The advertising component may generate a unique identification code for each lead request, which responders may use to initiate an interactive screening session with the advertising unit. The advertising component may track the unique identification code, responder's caller ID, and the state of the screening session to maintain the proper sequence of interactions.

### CROSS-REFERENCE TO RELATED APPLICATIONS

This application claims the benefit of U.S. Provisional Application No. 61/793,096, filed Mar. 15, 2013, and also claims the benefit of U.S. Provisional Application No. 61/792,969, filed Mar. 15, 2013, and also claims the benefit of U.S. Provisional Application No. 61/792,418, filed Mar. 15, 2013, and also claims the benefit of U.S. Provisional Application No. 61/792,597, filed Mar. 15, 2013, and also claims the benefit of U.S. Provisional Application No. 61/792,646, filed Mar. 15, 2013, the disclosures of which are hereby incorporated in their entirety by reference herein.

### TECHNICAL FIELD

The present disclosure relates to a digital advertising system and method for screening leads using interactive advertising units to communicate in real-time over mobile messaging services.

### SUMMARY

One or more embodiments of the present disclosure are directed towards an interactive digital advertising system and method. The system may include an advertising component for generating qualified leads in response to a lead request using interactive advertising units. The advertising system may provide “real-time” matching of leads, which may be validated based on a criteria defined by the lead requestor, to the services or products offered by the lead requestor. The interactive advertising units may communicate with leads over mobile messaging services, such as short message service (SMS), instant messaging (IM) service, or the like. Accordingly, an interactive advertising unit may be built to run on a mobile data service to provide real-time computerized screening of responders to the lead request. The advertising component may generate a unique identification code for each lead request, which responders may use to initiate an interactive screening session with the advertising unit. The advertising component may track the unique identification code, responder's caller ID, and the state of the screening session to maintain the proper sequence of interactions.

### BRIEF DESCRIPTION OF THE DRAWINGS

FIG. 1 is a simplified, exemplary network diagram of a digital advertising system, in accordance with one or more embodiments of the present disclosure;

FIG. 2 is a simplified, exemplary block diagram of the digital advertising system, in accordance with one or more embodiments of the present disclosure;

FIG. 3 depicts an exemplary web form for submitting a lead request, in accordance with one or more embodiments of the present disclosure;

FIG. 4 depicts an exemplary online screen that may be displayed once a lead request has been submitted, in accordance with one or more embodiments of the present disclosure;

FIG. 5 depicts an exemplary interactive advertising unit, in accordance with one or more embodiments of the present disclosure;

FIG. 6 depicts another view of the exemplary interactive advertising unit from FIG. 5, in accordance with one or more embodiments of the present disclosure;

FIG. 7 depicts yet another view of the exemplary interactive advertising unit from FIG. 5, in accordance with one or more embodiments of the present disclosure;

FIG. 8 depicts an exemplary view of a social networking site including a message post requesting endorsements, in accordance with one or more embodiments of the present disclosure;

FIG. 9 depicts an exemplary view of a browser for viewing leads, in accordance with one or more embodiments of the present disclosure;

FIG. 10 depicts an alternative view of a browser include a full lead profile post-purchase, in accordance with one or more embodiments of the present disclosure;

FIG. 11 is a simplified, exemplary flow diagram illustrating a method for generating and presenting leads, in accordance with one or more embodiments of the present disclosure;

FIG. 12 is a simplified, exemplary block diagram of a number of adaptive advertising units, in accordance with one or more embodiments of the present disclosure;

FIG. 13 is a simplified, exemplary flow diagram illustrating a method for adapting interactive advertising units, in accordance with one or more embodiments of the present disclosure;

FIG. 14 is simplified, exemplary system architecture diagram of a digital advertising platform, in accordance with one more additional embodiments of the present disclosure; and

FIG. 15 is a simplified, exemplary flow diagram depicting a process for generating qualified leads in an online job recruitment advertising platform, in accordance with yet one more additional embodiments of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

As used in this disclosure, the terms “component,” “unit” and “system” are intended to refer to a computer-related entity, either hardware, a combination of hardware and software, software, or software in execution. For example, a component can be, but is not limited to being, a process running on a processor, a processor, an object, an executable, a thread of execution, a program, an algorithm and/or a computer. By way of illustration, both an application running on a server and the server can be a component. A component can be localized on one computer and/or distributed between two or more computers. Likewise, as used in this disclosure, the term “database” is intended to refer to one or more computer-related entities for the storage and access of data; and does not necessarily pertain to any manner or structure in which such data is stored. Further, the recitation of a first database and a second database does not necessarily require that such databases are separate from one another, either with respect to the data storage location(s), device(s) and/or structure(s).

Implementations of illustrative embodiments disclosed herein may be captured in programmed code stored on machine readable storage mediums, such as, but not limited to, computer disks, CDs, DVDs, hard disk drives, programmable memories, flash memories and other permanent or temporary memory sources. Execution of the programmed code may cause an executing processor to perform one or more of the methods described herein in an exemplary manner.

A network diagram of an exemplary digital advertising system 10 is illustrated in FIG. 1. In one embodiment, the advertising system 10 can be implemented as a networked client-server communications system. To this end, the system 10 may include one or more client devices 12, one or more application servers 14, and one or more database servers 16 connected to one or more databases 18. Each of these devices may communicate with each other via a connection to one or more communications channels 20. The communications channels 20 may be any suitable communications channels such as the Internet, cable, satellite, local area network, wide area networks, telephone networks, or the like. Any of the devices described herein may be directly connected to each other and/or connected over one or more networks 22. While the application server 14 and the database server 16 are illustrated as separate computing devices, an application server and a database server may be combined in a single server machine.

One application server 14 may provide one or more functions or services to a number of client devices 12. Accordingly, each application server 14 may be a high-end computing device having a large storage capacity, one or more fast microprocessors, and one or more high-speed network connections. One function or service provided by the application server 14 may be a web application, and the components of the application server may support the construction of dynamic web pages.

One database server 16 may provide database services to the application server 14, the number of client devices 12, or both. Information stored in the one or more databases 18 may be requested from the database server 16 through a “front end” running on a client device 12, such as a web application. On the back end, the database server 16 may handle tasks such as data analysis and storage.

Relative to a typical application server 14 or database server 16, each client device 12 may typically include less storage capacity, less processing power, and a slower network connection. For example, a client device 12 may be a personal computer, a portable computer, a personal digital assistant (PDA), mobile phone, a microprocessor-based entertainment appliance, a peer device or other common network node. The client device 12 may be configured to run a client program (e.g., a web browser, an instant messaging service, a text messaging service, or the like) that can access the one or more functions or services provided by the application server 14. Moreover, the client device 12 may access information or other content stored at the application server 14 or the database server 16.

The system 10 may provide an interactive digital advertising platform for use by various media sites or other advertisers. Accordingly, the application server 14, database server 16 and database 18 may be operated by an advertiser 24. According to one or more embodiments, the interactive digital advertising platform may act as a middleware solution that media sites can use as an advertising monetization tool. In the context of the disclosed advertising system, the client devices 12 may be representative of various client entities that interact with the advertiser 24 through a client device 12. As shown in FIG. 1, the clients may at least include lead requestors 26 and responders 28. Additionally, the clients may further include third-party validators 30 in accordance with one or more embodiments of the present disclosure, as will be described in greater detail below.

The present disclosure relates generally to a digital advertising platform for generating qualified leads using dynamic, interactive advertising units. As will be described in greater detail below, the interactive advertising units may be adaptive based on a combination of “observed” information and “declared” information. Observed information may include browsing habits and search patterns of users, pre-screening speed, social media behavior, or the like. Declared information, on the other hand, may include responses to specific questions served by advertising units. Accordingly, the system 10 embodies an interconnected digital advertising ecosystem in which lead requestors may be linked together through self-learning technology capable of aggregating performance data of advertising units across multiple sources and leveraging the information learned therefrom to improve current and future advertising units in real time.

For exemplary purposes, various aspects of the present disclosure will be described herein with specific reference to a system for generating interactive advertising units for use in recruiting potential employees, particularly hourly-wage workers, on behalf of employers. However, it is not intended that these aspects be limited to an hourly jobs recruiting platform. Rather, the disclosed embodiments are merely exemplary of an invention that may be embodied in various and alternative forms. Specific structural and functional details disclosed herein merely form a representative basis for teaching one skilled in the art to variously employ the subject matter described in the present disclosure. Therefore, the digital advertising platform disclosed in the present disclosure may be equally applicable to other vertical or horizontal advertising units for generating qualified leads, such as may be used in car sales, insurance sales, online dating services, and credit card approvals, to name just a few.

FIG. 2 illustrates a high-level block diagram of the exemplary digital advertising system 10. Central to the system 10 is an advertising component 32, which provides the platform for generating qualified leads. The advertising component 32 may include a number of sub-components or modules for performing the various functions provided by the digital advertising platform. Similar to a component, a module may refer to a process running on a processor, a processor, an object, an executable, a thread of execution, a program, an algorithm and/or a computer. Thus, each module may not necessarily refer to a discrete piece of hardware, software, or some combination thereof. Rather, the exemplary modules described in the present disclosure are merely intended to identify various functions of the advertising component 32 in structural terms.

A lead requestor 26 may interact with the advertising component 32 online. A lead requestor may be an individual or entity seeking qualified leads via the advertising component 32. In particular, the lead requestor 26 may submit a request for leads to the advertising component 32 via an online, fillable web form accessed through a website hosted by the advertiser 24. Leads may be requested in this manner using any type of client device 12, which may include mobile devices such as smart phones or tablets in addition to personal computers and the like.

The advertising component 32 may be integrated as part of a dedicated digital advertising source having its own interactive website. Lead requestors may connect to the advertising component 32 directly by logging on to the dedicated site hosted by the digital advertiser. Alternatively, the advertising component 32 may be a middleware solution for various media sites, as previously mentioned. To this end, a lead requestor 26 may log on to a third-party media site to submit a lead request. The third-party site may then send the lead request to the advertising component 32 using, for example, an extensible markup language (XML) file. The third-party site may also send a lead requestor 26 to a co-branded site hosted by the digital advertising source operating the advertising component 32. In this manner, it may appear to lead requestors 26 that they are on the third-party site even though they may actually be on the source site for the advertising component 32.

In the context of an hourly jobs recruiting platform, the advertising component 32 may be a middleware solution for a number of job boards. Further, a lead requestor 26 may be an employer seeking to hire an hourly-wage employee (e.g., a barista in a coffee shop, a cook in a diner, etc.). The employer may log on to a third-party website, such as a job board site, and post a job using the third-party's site, which sends the job posting to the advertising component 32. Alternatively, the employer may log on to the source website hosted by the job recruitment platform provider. Whichever the method, the employer may post a job opening through the advertising component 32 by submitting a description and various details relating to the position and its requirements.

FIG. 3 illustrates an exemplary web form 60 for submitting a lead request, in accordance with one or more embodiments of the present disclosure. In the particular example shown, the web form 60 may provide a way for an employer to request leads for a job opening. An employer may log on to a particular job recruiting website and select an option to post a new job. Although the example depicted in FIG. 3 pertains to a job recruiting platform, it is intended to be generally illustrative of the manner in which leads may be requested for any advertising platform. Thus, the advertising component 32 may receive particular advertising requests via lead request web forms filled out and electronically submitted by lead requestors 26. In response to a lead request, an interactive advertising unit 34 may be generated and published by the advertising component 32.

The lead request web form 60 may include a general details section 62. A lead requestor 26 may define the basic advertisement parameters for a lead request in the general details section 62. For instance, the exemplary job posting web form, the general details section 62 may include blanks or other widgets for employers to input information about the job opening such as a job title, company name and job location. The advertising component 32 may require certain basic information about a particular lead request before it can be submitted by a lead requestor 26. Further, the general details section 62 may include space for receiving optional information as well from a lead requestor 26. For example, an employer may include additional details such as pay rate, job shift, job type, minimum age, etc.

The lead request web form 60 may also include a one or more user selectable inquiry sections 64. Each user selectable inquiry section 64 may provide space for lead requestors to select a number of pre-screening inquiries 66 to be made on their behalf by the interactive advertising unit 34. The pre-screening inquiries 66 may be selected, for example, by checking an adjacent box or selecting an adjacent button. The pre-screening inquiries 66 may include questions, criteria, conditions, or other information prompts for potential responders 28. For example, the pre-screening inquiries 66 may include pre-written interview questions to be asked of job applicant responders by interactive advertising unit 34. Moreover, a number of the pre-screening inquiries available for selection may vary based on the specifics of the lead request. For instance, at least some of the selectable interview questions may be the same for any job type or description, while others may depend on the particular job position to be posted. Interview questions relevant to an employer seeking a barista, for example, may not be relevant to an employer seeking a janitor.

According to one or more embodiments of the present disclosure, the user selectable inquiry sections 64 may include an on-screen inquiry section 68 and a telephone inquiry section 70. In the on-screen inquiry section 68, a lead requestor 26 may select a number of inquiries 66 to be asked by an interactive advertising unit 34 soliciting written responses or other manual feedback from responders 28. On the other hand, in the telephone inquiry section 70, a lead requestor 26 may select number of inquiries 66 for soliciting an audible response during a telephone interview session. As will be explained in greater detail below, an interactive advertising unit 34 may call a responder 28 to solicit the audible responses to inquiries selected by the lead requestor 26 in the telephone inquiry section 70.

The pre-screening inquiries 66 may be grouped into a number of different categories 72. As shown in FIG. 3, selectable interview questions may be grouped into such exemplary topics as attendance, teamwork, motivation, character, employability, communications, dependability, customer service, or job skills. In order to streamline the pre-screening process, the quantity of pre-screening inquiries 66 that may be chosen by a lead requestor 26 may be limited in number. In this manner, a lead requestor 26 may select inquiries 66 believed to be the most relevant in uncovering qualified leads. In one or more embodiments, lead requestors 26 may input their own pre-screening inquiries 66. Moreover, such crowd-sourced pre-screening inquiries may be added to a library of user selectable pre-written inquiries 66 for future use.

Once the lead requestor 26 has completed the general details section 62 and each user selectable inquiry section 64, the advertising request may be submitted online where it can be received by the advertising component 32. FIG. 4 depicts an exemplary online screen 74 that may be displayed once the advertising request has been submitted. Here, the advertising component 32 may inform lead requestors 26 how and/or when they will be notified of potential leads. In general, the advertising component 32 may publish digital advertising units 34 online in various media sites that form a part of the interconnected digital advertising ecosystem. Further, as illustrated in FIG. 4, the advertising component 32 may also tap into the lead requestor's network, with proper authorization, on its behalf. To this end, the advertising component 32 may automatically generate messages pertaining to the lead request for email distribution or publication to one or more social media networks (e.g., Facebook, LinkedIn Twitter, blogs, etc.) of the lead requestor. Additionally or alternatively, the advertising component 32 may provide lead requestors 26 with an option to post their advertisement on a classified advertisements website, such as Craigslist. Moreover, these automatically generated messages may include instructions and/or a hyperlink for responders 28. Accordingly, the online screen 74 may include one or more widgets 76 that a lead requestor 26 may engage to tap into these additional networks in a known manner.

Referring back to FIG. 1, the advertising component 32 may be configured to receive a lead request having at least a general description and a number of user selectable pre-screening inquiries 66. Moreover, the pre-screening inquiries 66 may solicit text and or voice responses from potential leads. In response to the lead request, an interactive advertising unit 34 may be generated and published by the advertising component 32, as previously mentioned. Accordingly, the advertising component 32 may include an advertisement publishing module 36 for composing interactive advertising units 34 based on input received from lead requestors 26.

At its most basic level, an interactive advertising unit 34 may be constructed from a number of data elements representative of data, stored in the databases 18, that is organized and conveyed to a user in an understandable manner. According to one or more embodiments, an interactive advertising unit 34 may be embodied as an interactive web page, an inline frame or object elements within a web page, or the like. Each interactive advertising unit 34 may include an advertising message 38 and a call-to-action message 40. The advertising message 38 may convey the nature of the request to the public, while the call-to-action message 40 may lead interested recipients of the advertising message to start an interactive experience with the advertising unit 34. Responsive recipients of the advertising message 38 are referred to generically throughout the present disclosure as responders 28. For instance, the advertising message 38 in the exemplary hourly jobs recruiting platform may contain a description of a job opening posted by an employer. Therefore, the responders 28 may be job applicants in this context. However, responders 28 could include credit card applicants, car buyers, or the like, depending on the particular implementation of the advertising system and method described in the present disclosure.

The call-to-action message 40 may include instructions for responding to the advertising message 38 and may provide one or more means of contact offered by the interactive advertising unit 34, such as a phone number, a URL, text messaging (e.g., SMS), instant messaging (IM), and the like. The call-to-action message 40 may further include call-to-action buttons or widgets (not shown) that may automatically take action on the responder's behalf upon activation. As used herein, the term “widget” generally refers to a software-based component of any graphical user interface in which a user interacts, whether it be on a computer, a website, a mobile device, a hand-held device, and the like. For example, a widget may be a graphical user interface element that may provide a single interaction point for manipulating a given kind of data. In one example, a widget may include a web widget, which may include any code that may be embedded within a page of HTML, e.g., a web page.

The advertising unit 34 may be interactive such that responders 28 may engage with the advertising component 32 via the interactive advertising unit. In this regard, the advertising unit 34 may do more than send a message to a crowd as static text. It may also invite users to start an interactive experience. For instance, the advertising unit 34 may solicit responses and other feedback from responders 28 based at least in part on the pre-screening inquiries 66 selected by the lead requestor 26. Accordingly, the interactive advertising unit 34 may essentially prompt responders 28 to qualify themselves as potential leads, which can then be offered to a lead requestor 26 for purchase. For this purpose, the advertising component 32 may further include a responder interaction module 42 that coordinates and facilitates these interactions with a responder 28. The interactive advertising unit 34 may essentially interview a responder 28 by asking the responder questions or requesting the responder to provide relevant information based on the lead requestor-selected pre-screening inquiries 66. The interactive advertising unit 34 may prompt text-based and/or voice-based responses.

FIG. 5 depicts an exemplary interactive advertising unit 34 for a job board posting running on a website. The interactive advertising unit 34 may conduct an online interview with a job applicant responder. Accordingly, the advertising unit 34 may ask a job applicant responder a number of preselected interview questions. As described in the preceding paragraphs, the interview questions may be selected by the employer from group of possible interview questions when the job posting is created. Additionally or alternatively, employers may submit their own interview questions. The interactive advertising unit 34 may prompt text-based responses to select questions. As shown in FIG. 5, the applicant may type responses to a first series of interview questions 78 in text fields 80 adjacent to each question. In a web interview, the interactive advertising unit 34 may interact with responders 28 by laying out the questions and/or other dynamic elements on a web page, enabling responders 28 to complete the text-based portion of the interview in essentially a single transaction. Although the questions could be laid out over several web pages, the interactive advertising unit 34 running on a website may allow a responder 28 to address more than one question at a time. Accordingly, responses to all questions may be processed in a batch.

The advertising unit 34 may also be voice-powered. As shown in FIG. 6, the advertising unit 34 may also call the applicant to conduct an automated phone interview in which a number of additional interview questions may be asked, in accordance with one or more embodiments of the present disclosure. As with the text-based questions 78, the phone interview questions 82 may also be selected by the employer ahead of time. The advertising unit 34 may instruct the job applicant responder to enter a telephone number where the applicant can be reached into a numerical field 84. Once the telephone number is submitted, the advertising unit 34 may call the applicant to continue the interview process. The voiced-based responses to the phone interview questions may be recorded and analyzed by the advertising component 32 along with the text-based responses. In one or more embodiments, a responder 28 may optionally skip the phone interview portion of the pre-screening process.

If the interactive advertising unit 34 is running on a media website, a responder 28 may interact with the advertising unit without leaving the site. Of course, interactions with the advertising unit 34 may occur outside of a web browser context, as mentioned above. The advertising unit 34 may provide real-time computerized interactions with responders 28 over any number of alternative communication mediums, including telephone, SMS, IM services, and the like. Interactive advertising units 34 built to run on the mobile web can open the target advertising space up to a larger segment of the population for media companies, not just those with smart phones or access to Internet browsers. Individuals with feature phones lacking a browser or data plan can now engage with interactive advertising units 34 over SMS, for example.

The same web interview described above in connection with FIG. 5 may also be conducted over devices and/or protocols that are real-time in nature, such as phone SMS or IM chat. Conducting a real-time computerized interview with a responder 28 over SMS or IM can introduce unique challenges in comparison to an interactive web interview. Since there is no URL, in order to initiate the correct interview or other inquiry, the advertising component 32 may assign a unique identification code to each lead request (e.g., job posting). The unique identification code may then be used by responders 28, such as job applicants, to initiate an interview. According to one or more embodiments, a unique identification code may be reused or recycled. However, in order to avoid any overlap in lead requests, the advertising component 32 may wait a predetermined period of time after a lead request is closed and no longer available before the same code can be assigned to another lead request. These unique identification codes may also be published in offline advertisements, such as newspaper classified advertisements, which can have a longer shelf life than an online page. Therefore, the predetermined wait period before a unique identification code can be recycled may account for the longer shelf life of offline publications.

The unique identification codes may be produced in a non-serialized manner in order to reduce the likelihood of initiating the wrong interview due to a typing mistake by a responder 28. To this end, the advertising component 32 may employ a random number generator to select a random number between a range of numbers to assign as the unique identification code. The advertising component 32 may then check if there is an active identification code associated with another lead request within a predefined threshold around the number selected by the random number generator to minimize potential collisions between nearby numbers.

The advertising unit 34 may construct a SMS interview with a responder 28 using the same database 18 used to construct web interviews. The workflow may be consistent with that of a typical “live person” interview with real-time questions and responses. The advertising unit may present each question to a responder 28 in a SMS message or IM chat and wait for an answer in a reply message before presenting a subsequent question. Moreover, the interactive advertising unit 34 may account for the maximum permissible message length for the protocol employed and may break the message into parts accordingly. For example, messages longer than 160 bytes may be broken into two or more parts when using a SMS protocol. Based on each particular question, the advertising component may expect a certain range of allowed responses. If a received response is not within the expected range of acceptable responses, the advertising unit 34 may send a message to that effect to the responder 28.

The state of the interview may be kept in a database, such as database 18. This may be necessary to maintain the proper sequence of interactions with a responder 28 and match received responses with the corresponding questions. Accordingly, if the responder 28 takes a relatively long break between answering questions, the advertising unit 34 can recall to which question an eventual response correlates. Tracking and saving the state of an interview may also help if the interview is interrupted or otherwise fails to be completed. If the responder 28 attempts to initiate the same interview again using the unique identification code, the responder may be identified by the responder's caller ID attached to the SMS message or IM chat. The advertising unit 34 may recall the interview based on the unique identification code and caller ID and resume the interview where it last stopped.

According to one or more embodiments, the interactive advertising unit 34 may be multi-lingual. During interactions, the advertising unit 34 may transmit questions in a responder's native language. The advertising component 32 may also translate responses to a lead requestor's native language. The advertising component 32 may also be configured to transcribe verbal responses to text in various supported languages, which may then be translated to the lead requestor's native language for evaluation.

By interacting with the advertising unit 34 using any of the above-described devices or protocols, responders 28 to an advertising message 38 are essentially asked to qualify themselves as a potential lead. The advertising component 32 may essentially pre-screen responders 28 on behalf of the lead requestor 26 and may identify the top leads from the pool of responders 28 to present to the lead requestor 26 for purchase. In this manner, the advertising component 32 may evaluate and score each responder 28 based on the responder's responses and other associated interactions with the advertising unit 34. Moreover, the advertising component 32 may build a profile for each responder 28. To this end, the advertising component 32 may further include a profile building module 44. The profile may include information relating to the interactions between the advertising unit 34 and the responder 28, including text-based and/or voice-based responses to the pre-screening inquiries 66. By asking the responder 28 various questions or seeking other relevant information from the responder 28, the advertising unit 34 may help build a responder profile. For instance, the profile for a job applicant responder may essentially become the applicant's virtual resume and include the applicant's responses to the various interview questions, including recorded audio of each voice-based response. Accordingly, profiles may reflect responders' overall activity as a way of showing who they are to a lead requestor (e.g., an employer) that may want to purchase a lead based on a profile.

According to one or more embodiments of the present disclosure, the advertising component 32 may attempt to validate a responder 28 by collecting feedback from one or more third-party sources, referred to as validators 30. Accordingly, the advertising component 32 may further include a lead validation module 46 for engaging third party validators 30 and processing feedback receive therefrom. Validators 30 may include individuals acquainted with a responder 28 or other entities having a connection to the responder 28, which can provide references that further qualify the responder as a potential lead. For example, the advertising component 32 may request endorsements from validators 30 to include in the responder's profile. In certain implementations, responders 28 may be given the option of seeking endorsements to bolster the responder's profile. If a responder 28 desires to obtain endorsements, the advertising component 32 may facilitate the endorsement process by engaging a responder's acquaintances.

The advertising component 32 may solicit endorsements from the acquaintances on behalf of a responder 28 in a relatively frictionless manner to encourage feedback. The advertising component 32 may interact with endorsers or validators in a number of ways, including social media, instant messaging, SMS text messaging, or through other cellular phone services. For example, the advertising component 32 may request endorsements from a responder's contacts using a social media platform. Upon receiving authorization, the advertising component 32 may post a message on a responder's behalf seeking endorsements from the responder's social media contacts. The advertising component 32 may repurpose the comments section for collecting endorsements. Thus, the social media contacts may endorse the responder 28 by commenting on a corresponding post. In a similar way, the advertising component 32 may also collect endorsements by repurposing IM chats, SMS text messages, or the like, exchanged with third-party validators 30.

FIGS. 7 and 8 illustrate an example of how endorsements may be sought in the hourly job recruiting context using social media. As shown in FIG. 7, the advertising unit 34 may request authorization to post a message 86 through a social networking platform. With authorization from the job applicant responder, the advertising component 32 may post the message 86 on a social networking site 88 on the job applicant responder's behalf informing the applicant's friends or other social media contacts about the job the applicant is seeking, as shown in FIG. 8. The message 86 may include a request for endorsements that may aid in the evaluation of the applicant. The social media post may also include a link 90 to the actual job posting published by the advertising component 32 connecting a media site or online job board to the social media platform's distribution. Social media contacts may endorse the job applicant responder by commenting on the corresponding post. As previously described, the advertising component 32 may repurpose the comments section to collect endorsements from the job applicant's social media contacts. Endorsements may also include references from previous employers. Accordingly, the advertising component 32 may be configured to prompt one or more former employers of a job applicant responder to provide a reference.

In addition to obtaining personal endorsements, the advertising component 32 may collect additional information or references to further qualify a potential lead, such as bank references, medical references, skill references, or the like. Moreover, the third party references may not be limited to feedback from humans. According to one or more embodiments of the present disclosure, the advertising component 32 may collect endorsements, references, or other information to further qualify a lead by automatically querying a third party database. One such example may include obtaining a credit score for a potential lead applying for a credit card or bank loan. In certain instances, such as in the preceding example, the lead may have to provide authorization and/or personally identifiable information (e.g., social security number) to the advertising unit 34 before a third party database can be queried. The advertising unit 34 may prompt a responder 28 to provide at least a minimum level of personal information in order to verify that the responder is legitimate. The advertising component 32 may check the personal information against legal databases, such as those used by the FBI or DMV, to confirm a responder's identity and guard against spammers and bots. Overall lead quality may be improved by using a validator 30 to confirm that human responders are real people with legitimate backgrounds.

Validators 30 may also validate or authenticate other information previously submitted to the advertising unit 34 by a responder 28. To this end, the advertising component 32 may probe validators 30 to confirm or verify such information. For instance, the advertising component 32 may verify certain skills or credentials submitted by a responder 28 by probing an accreditation source or similar entity.

The responder 28 may be provided the opportunity to accept or reject each endorsement or reference. The option to accept or reject third party feedback may also depend on the particular implementation of the advertising system described in the present disclosure. For instance, while the option to accept or reject endorsements may be sensible in a job recruitment advertising platform, it may not be for other vertical advertising units.

Accepted endorsements may be incorporated into a responder's profile for potential review by a lead requestor 26. The endorsements may also be factored into the scoring algorithm used to evaluate the responder, as will be discussed below. To this end, the endorsements may be scrutinized and weighted by the advertising component 32. As an example, endorsements that are not relevant to the lead request may be filtered out. Moreover, an endorsement from a validator 30 that has been deemed credible may be weighted more heavily than an endorsement from a less credible endorser. The advertising component 32 may assess the credibility of validators 30 based on previous endorsements, such as whether a validator's endorsements are generally accepted by a responder 28. The credibility of validators 30 may also be based on the content of their endorsement, their relationship with the responder, the overall number of endorsements they give out, the nature and quantity of their friends or contacts, and the like.

A complex scoring algorithm may be employed by the advertising component 32 in the evaluation of each responder 28. The advertising component 32 may further include a responder scoring module 48 for this purpose. The scoring module 48 may evaluate a responder 28 based on the responder's responses to various inquiries or questions prompted by the interactive advertising unit 34. Additional criteria may be applied to the scoring algorithm in the evaluation of each responder 28, such as geographic proximity, endorsements or other validations, interests, responsiveness to the advertising unit 34, time spent engaging with the advertising unit 34, etc. The advertising component 32 may then rank the various responders 28 based on their scores and select a subset of candidates therefrom to present to the lead requestor 26 as potential leads. Rather than identify the best candidate for a lead requestor 26, the advertising component 32 may help the lead requestor 26 identify several top candidates to focus on and possibly purchase.

In the hourly job recruiting example, the interactive advertising unit 34 ultimately digitizes the initial interview process by automatically pre-screening responders 28 and filtering out the best candidates for an employer to review. Thus, employers may avoid having to interview a relatively large number of applicants themselves, thereby streamlining the hiring process. By employing the interactive advertising units 34 of the present disclosure, other types of advertising platforms outside of the job recruitment context may also enjoy the advantages of streamlined lead generation provided by the advertising system 10.

With reference to FIG. 9, leads 92 may be presented to the lead requestor 26 online. For instance, the lead requestor 26 may access an online account through a web portal to view leads 92 responsive to each advertisement request in a browser 94. According to one or more embodiments of the present disclosure, the advertising component 32 may provide lead requestors 26 with only a preview of each lead's profile 96. As such, only portions of a lead's profile 96 may be disclosed to the lead requestor 26. The partial lead profile 96 may include a free preview of at least one text answer 98 to an inquiry, such as an interview question. Moreover, the partial lead profile may include a free preview of a responder's voice answer 100 to a question. Alternatively, rather than a free preview of a text answer 98 or a voice answer 100, the advertising component 32 may offer a preview of answers at a discounted rate relative to the cost of purchasing the full profile. The profile 96 may also include a score 102 that the lead 92 was assessed by the advertising component's scoring module 48. The profiles 96 presented by the advertising component 32 may be anonymous; the names and contact information for each lead 92 may be withheld from the lead requestor 26. The lead requestor 26 may purchase the lead's full profile 96 and contact information from the advertising component 32. To facilitate the purchasing transactions, the advertising component 32 may also include a transaction processing module 50.

Once purchased, the advertising component 32 may provide the lead requestor 26 access to a lead's full profile 96, as shown in FIG. 10. In this manner, the lead requestor 26 can review all interactions between each lead 92 and the associated advertising unit 34. For instance, the lead profile 96 may contain responses to interview questions provided by a job applicant responder, including text answers 98 and voice answers 100. The lead profile 96 may also include endorsements 104 from third-party validators 30. Further, a responder's profile 96 may also include interactions between the responder 28 and other relevant advertising units 34.

According to one or more alternate embodiments, the advertising component 32 may provide the lead requestor 26 access to a lead's full profile 96 prior to purchase. The full profile presented by the advertising component 32 may still be anonymous prior to purchase. However, the lead requestor 26 may have full access to the profile help determine whether to purchase the lead's contact information. When a lead requestor 26 identifies a lead they are interested in, the lead's contact information can then be purchased from the advertising component 32 as set forth above.

FIG. 11 is a simplified, exemplary flow chart depicting a method 300 for providing leads in accordance with one or more embodiments of the present disclosure. At step 305, the advertising component 32 may receive a request for leads from a lead requestor 26. The request may include a description of the advertisement as well as the selection of various pre-screening questions to ask potential responders 28. From the lead request, the advertising component 32 may generate and publish a digital interactive advertising unit 34, as provided at step 310. The advertising unit 34 may be published with a number of online sources, including on advertiser media sites, within search browsers, in electronic mail, and the like.

The advertising component 32 may prioritize the advertising units 34 it shows to users. For instance, a publication priority may be given to an advertising unit that has yielded relatively fewer leads compared to other advertising units. To help balance out the number of leads generated, the advertising component 32 may show advertising units with a lower number of leads first. The advertising component 32 may also factor in the number of leads already purchased by a lead requestor 26 when determining whether, or how frequently, to serve a corresponding advertising unit 34. If the quantity of leads already purchased tends to indicate that few, if any, additional leads will be purchased, the advertising component 32 may serve the advertising unit 34 less frequently, or stop altogether. The future purchasing behavior of a lead requestor 26 may be predicted by the advertising component 32 based on trends identified from past purchasing behavior. The past purchasing behavior may be specific to the lead requestor 26. For example, if historical purchase data associated with a particular lead requestor 26 is available, the advertising component 32 may evaluate the number of leads the lead requestor typically purchases per lead request. Based on this past purchase behavior, the advertising component 32 may predict the number of leads the lead requestor might purchase for a pending lead request. If the lead requestor has already purchased the typical allotment, the advertising component 32 may lower the publication priority of the corresponding advertising unit 34. Likewise, the advertising component 32 may identify other lead purchasing trends that are not necessarily specific to a particular lead requestor 26. Predictions may be based on purchase trends for all advertising units, advertising units sharing one or more similarities, or the like.

At step 315, the advertising component 32 may receive call-to-action responses from a number of responders 28 to the advertising unit 34. The advertising unit 34 may interact with each responder 28 in a number of ways based on the call-to-action, as previously described. For instance, the advertising unit 34 may interact with a responder 28 online, such as through a web page or instant messaging client. Additionally or alternatively, the advertising unit 34 may interact with a responder 28 over the phone or SMS.

At step 320, the advertising unit 34 may interact with a responder 28 and solicit relevant information for use in pre-screening the responder. For instance, the advertising unit 34 may ask the responder 28 a number of questions prompting the responder to self-qualify as a potential lead to present to the lead requestor 26. The advertising unit 34 may further inquire whether the responder 28 would like to collect third-party endorsements to help bolster the responder's candidacy as a potential lead, as provided at step 325. If the responder 28 wishes to seek endorsements from acquaintances, the advertising component 32 may publish a request for endorsements to the acquaintances on the responder's behalf, at step 330. For example, the advertising component 32 may post a message seeking endorsements on a responder's social media profile and repurpose comments to the post from the responder's social media contacts as endorsements. At step 335, the advertising component 32 may incorporate the endorsements into the responder's profile. The responder 28 may be allowed to accept or reject each third-party endorsement.

At step 340, each responder may be evaluated and scored based on responses given to the advertising unit 34. Moreover, if endorsements were collected, the endorsements may be factored into the scoring algorithm. Based on the scores, a number of the top leads may be identified. At step 345, the leads may be presented to the lead requestor 26 for possible purchase. The presentation of leads may include a preview only of each lead's profile or may include full access to each lead's entire profile. If a lead looks promising, the lead requestor 26 may be given the opportunity to purchase the lead's contact information for follow-up. Alternatively, a purchaser can bid on the lead's price. In this regard, several purchasers may, in effect, compete for the same lead. At step 350, the advertising component 32 may determine whether any leads have been purchased. If the purchase of one or more leads has been requested, the advertising component 32 may then transmit lead contact information to the lead requestor 26, at step 355.

At step 360, the advertising component 32 may then determine whether the advertising unit 34 has expired. An advertising unit 34 may expire for any number of reasons. One such reason may occur when the lead requestor 26 informs the advertising component 32 that additional leads are not required. For instance, an employer may indicate that a job position for which leads were requested has been filled. Thus, the need for additional leads may be negated. Other reasons to expire an advertising unit may be due to such things as the number of pending leads that have not been reviewed yet or the amount of revenue the advertising unit has generated. If the advertising component 32 is still active, the process may return to step 345 for the presentation of additional leads. If no leads are purchased at step 350, the method may proceed directly to step 360 for a determination as to whether the advertising unit 34 has expired.

If a lead request is ultimately filled, the advertising component 32 may receive feedback from the lead requestor 26 to that effect. Depending on the implementation, the advertising component 32 may then flag the lead so the lead is not offered to other lead requestors. For instance, the advertising component 32 may flag hired applicants so that they are not offered to other employers as potential leads where they can then be poached.

In addition to being interactive, the advertising unit 34 may also be dynamic. In particular, the advertising component 32 may include one or more learning modules that learn from the interactivity between various advertising units 34 and responders 28. Through self-learning, the advertising component 32 may identify optimal advertising messages 38 for a particular advertising unit 34. Moreover, the advertising component 32 may learn to adapt a particular advertising unit's interaction prompts (e.g., questions or information requests) based on results of other advertising units 34. Interactive advertising units 34 containing dynamic content may be constructed on the fly from data extracted from databases 18 based on user (e.g., lead requestor, responder, etc.) information and interactions, including responses to questions.

The advertising component 32 may be an aggregator of information and data learned from all different advertising units 34. Moreover, as a middleware solution, in which the advertising component 32 provides services for numerous advertisers 24, aggregated advertisement performance can be observed and leveraged from multiple sources. From the vast number of observed interactions and feedback, the advertising component 32 can identify trends and modify an interactive advertising unit 34 in real time.

To this end, the advertising component 32 may aggregate the feedback generated from multiple advertising units 34, including feedback received from other advertising sources, and apply various learning algorithms to optimize current and future advertising units. For instance, the advertising component 32 may include an advertising message learning module 52. The advertising message learning module 52 may be employed to modify the advertising message 38 or description contained in an interactive advertising unit 34 in real time based on the observed aggregated performance of other advertising units across multiple advertisers 24. Thus, the advertising message 38 or description may change in real time based on the performance of similar advertising units 34. For instance, if one advertising unit 34 has a relatively large hit rate or number of impressions, the advertising message 38 for similar advertising units may be modified to attract more responders 28. The advertising message 38 may be further modified based on the feedback from user engagement, including call-to-action results and crowdsourcing inputs. This adaptability may be replicated throughout the ecosystem of similar advertising units without intervention from lead requestors as advertising units self-learn to deliver the best possible performance. For example, a lead requestor 26 seeking credit cards applications may start with an advertising message “A,” a call-to-action “B,” and a set of questions “1,” “2,” and “3.” Based on the collective performance of similar advertising units, the advertising component 32 may learn that the optimal advertising message is still “A,” but that call-to-action “M” and questions “1,” “2,” and “4” provide better results.

Accordingly, multiple permutations of the same advertising unit 34 may be deployed based on user engagement and aggregated performance throughout the advertising ecosystem. Additionally, the various learning algorithms may account for lead results post-purchase, including the perceived long-term successes and failures of purchased leads. For example, the advertising component 32 may learn from purchased leads that do not result in a hire, as well as those that do.

Not only may the advertising messages 38 be dynamic, the interactions between an advertising unit 34 and responders 28 may also be modified in real-time based on feedback aggregated from other advertising units. Accordingly, the advertising component 32 may further include an interaction and adaptation learning module 54 for applying a learning algorithm to feedback from observed aggregated performance of advertising units 34 to improve an advertising unit's interactions with responders 28. For example, the selected interview questions used to pre-screen job applicants may be modified or substituted in real time so that an advertising unit 34 can solicit responses that tend to yield the best results. By the same token, a list of available interview questions from which an employer may select when requesting leads for a job opening may constantly be updated to reflect the interview questions deemed most effective in other advertising units 34. Additionally, lead requestors 26 may submit their own questions to be asked by an advertising unit 34. As feedback on the effectiveness of these questions is received, they may be further modified and/or added to the list of available questions from which other lead requestors may select.

FIG. 12 is a simplified, exemplary block diagram illustrating the self-learning features of the advertising component 32 for generating dynamic advertising units 34. As seen therein, feedback relating to the performance of an advertising message 38 may be applied to an advertising message learning algorithm 56 forming at least a part of the advertising message learning module 52. Based on the learned performance of other advertising units 34, the advertising message 38 on a particular advertising unit 38 may be modified in real-time to optimize its effectiveness. Likewise, feedback relating to the effectiveness of call-to-action messages 40 and other interactions between advertising units 34 and responders 28 may be aggregated and applied to an advertising unit interaction learning algorithm 58 forming at least a part of the interaction learning and adaption module 54. The interaction learning algorithm 58 may help identify optimal interaction prompts for an advertising unit 34 to incorporate, including suitable questions to ask responders 28.

FIG. 13 is a simplified, exemplary flow chart depicting a method for dynamically modifying interactive advertising units 34 based on aggregated performance. Steps 505-520 may be similar to steps 305-320 as shown and described in connection with FIG. 11. Thus, the description of those steps will not be repeated here for purposes of brevity. At step 525, the performance of various advertising units 34 may be observed, aggregated and analyzed by the advertising component 32. The advertising component 32 may learn from the aggregated performance of advertising units 34 and may revise current advertising units accordingly, at step 530. For instance, the advertising component 32 may modify the advertising message 38 and/or call-to-action message 40 for a particular advertising unit 34 in real time based on learned performance of other advertising units that yielded a high number of responses. Once the advertising unit 34 has been modified at step 530, the process may return to step 510 wherein the revised advertising unit may be republished.

Similarly, at step 535, the advertising component 32 may analyze the aggregated performance of advertising units 34 based on interactions with responders 28. In particular, the advertising component 32 may identify the best communication channels to emphasize in future interactions. Additionally, the advertising component 32 may learn which questions or information requests tend to lead to the identification of successful leads. Accordingly, the advertising component 32 may modify or otherwise adapt advertising units 34 based on the trends and other information learned from the analysis of prior advertising units, as provided at step 540.

As previously described, the system and method for dynamically modifying an interactive advertising unit 34 may be replicated throughout the entire ecosystem of similar advertising units, including those requested from different sources, without lead requestor involvement as the advertising units self-learn to deliver optimum performance.

According to one or more embodiments of the present disclosure, the data obtained through interactions with responders 28 to various advertising units 34 may be further leveraged to “passively” advertise for lead requestors 26. Using passive advertising, the advertising component 32 may generate leads for a lead requestor 26 without responders even seeing a corresponding advertising unit 34. Rather, lead candidates may be selected from a pool of responders 28 to other advertising units whose profiles suggest a match to one or more requirements or other criteria of the lead request. Thus, responders 28 need not actively respond to a particular advertising unit 34 to be considered a viable candidate. This may be possible with data standardization. For instance, in the job recruiting platform, a barista is a barista. In effect, an applicant responder that applies for a job as a barista by responding to a particular advertising unit 34 publicizing that job opening can be considered a candidate for similar job postings without having to go through the interview process for each job posting. Thus, advertising component 32 may function as a virtual temporary worker agency. An employer in need of a replacement worker in an emergency would not necessarily even need to post a job. Rather, the employer can request the advertising component 32 to identify available leads that applied to similar jobs or that applied to the employer in the past.

Accordingly, the advertising component 32 can provide a lead requestor with leads selected from responders to similar lead requests. Additionally or alternatively, the advertising component 32 can provide a lead requestor with leads selected from responders with a profile match to one or more requirements, qualifications or other criteria of the lead request. The match between profile characteristics and lead request requirements may not necessarily be exact, particularly when considering answers to interview questions. Rather, the advertising component 32 may employ a proximity-based matching algorithm to identify quality leads that didn't directly respond to the subject advertising unit 34. The proximity-based matching may consider several lead requirements beyond just geographical matches.

FIG. 14 depicts a simplified system architecture diagram of an exemplary digital advertising platform, in accordance with one or more embodiments of the present disclosure. In this particular example, client-server system architecture for a co-brandable job recruitment advertising platform is illustrated. As shown the system architecture may include a number of server components and modules for matching and qualifying leads, a number of databases for aggregating and storing relevant data, and one or more interfaces for communicating with various system clients, including job seekers and employers.

FIG. 15 is a simplified flow diagram depicting one exemplary process for generating qualified leads in an online job recruitment advertising platform. It should be understood that one or more steps may be modified, rearranged, substituted or omitted depending on a particular implementation without departing from the scope of the present disclosure.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer system for qualifying potential leads over an electronic messaging service comprising a computer having non-transitory memory for storing machine instructions that are to be executed by the computer, the machine instructions when executed by the computer implement the following functions:
receiving a lead request from a lead requestor, the lead request including a description of an advertisement and a selection of a set of pre-screening inquiries;
generating at least one digital interactive advertising unit corresponding to the advertisement based on the lead request, the interactive advertising unit including an advertising message and a call-to-action message prompting individuals to initiate a computerized screening session with the interactive advertising unit in response to the advertising message over an electronic messaging service;
receiving a call-to-action response via the electronic messaging service from a responder responding to the interactive advertising unit; and
executing the computerized screening session with the responder in response to the call-to-action response, the real-time computerized screening session based at least in part on the set of pre-screening inquiries to collect responder information.

2. The system of claim 1, wherein the executing function includes:
transmitting at least one inquiry message to the responder over the electronic messaging service; and
receiving an answer message from the responder in reply to the inquiry message over the electronic messaging service.

3. The system of claim 2, wherein the inquiry message is selected from the set of pre-screening inquiries selected with the lead request.

4. The system of claim 2, wherein the executing function further includes:
transmitting a subsequent inquiry message to the responder over the electronic messaging service upon receiving the answer message from the responder; and
receiving a subsequent answer message from the responder in reply to the subsequent inquiry message over the electronic messaging service.

5. The system of claim 4, wherein the subsequent inquiry message is selected from the set of pre-screening inquiries selected with the lead request.

6. The system of claim 2, wherein the machine instructions when executed by the computer further implement the following function:
dividing the inquiry message into parts when the inquiry message exceeds a maximum permissible message length for an electronic messaging protocol associated with the electronic messaging service.

7. The system of claim 2, wherein the inquiry message requires a response from a predetermined range of acceptable responses.

8. The system of claim 7, wherein the machine instructions when executed by the computer further implement the following function:
transmitting a notification message to the responder over the electronic messaging service when the answer message is not within the predetermined range of acceptable responses.

9. The system of claim 8, wherein the notification message includes a prompt to submit a new answer message to the inquiry message.

10. The system of claim 2, wherein the machine instructions when executed by the computer further implement the following function:
matching received answer messages with corresponding inquiry messages in a database.

11. The system of claim 10, wherein the machine instructions when executed by the computer further implement the following functions:
tracking a state of progress of the computerized screening session to maintain a proper sequence of inquiries with the responder; and
storing the state of progress in the database when an interruption to the computerized screening session occurs.

12. The system of claim 11, wherein the machine instructions when executed by the computer further implement the following function:
recalling the state of progress of the computerized screening session when the computerized screening session resumes.

13. The system of claim 12, wherein the computerized screening session is resumed upon receiving a resume message from the responder over the electronic messaging service, the resume message including at least a responder identification code and unique identification code associated with the lead request.

14. The system of claim 2, wherein the machine instructions when executed by the computer further implement the following function:
transmitting the at least one inquiry message to the responder in the responder's native language.

15. The system of claim 1, wherein the electronic messaging service is a mobile messaging service.

16. The system of claim 15, wherein the mobile messaging service includes short message service (SMS).

17. The system of claim 15, wherein the mobile messaging service includes an instant messaging (IM) service.

18. The system of claim 1, wherein the electronic messaging service is a web-based messaging service.

19. The system of claim 18, wherein the web-based messaging service includes an instant messaging (IM) service.

20. The system of claim 1, wherein the machine instructions when executed by the computer further implement the following function:
receiving an endorsement of the responder from a third-party over the electronic messaging service.

21. The system of claim 1, wherein the call-to-action message includes a unique identification code associated with the lead request.

22. The system of claim 21, wherein the call-to-action response includes the unique identification code and a responder identification code that uniquely identifies the responder.

23. The system of claim 22, wherein the responder identification code is a caller ID.

24. The system of claim 22, wherein the responder identification code is automatically attached to the call-to-action response as part of an electronic messaging protocol associated with the electronic messaging service.

25. The system of claim 21, wherein unique identification codes associated with different lead requests are generated in a non-serialized manner in order to reduce the likelihood of initiating a wrong computerized screening session due to a typing mistake by the responder.

26. The system of claim 21, wherein the machine instructions when executed by the computer further implement the following function:
generating the unique identification code using a random number generator to select a random number between a range of numbers to assign as the unique identification code.

27. The system of claim 26, wherein the machine instructions when executed by the computer further implement the following function:
checking for an active unique identification code associated with another lead request within a predefined threshold around the number selected by the random number generator to minimize potential collisions between nearby numbers.

28. The system of claim 21, wherein the unique identification code is reusable once the associated lead request is closed.

29. The system of claim 28, wherein the machine instructions when executed by the computer further implement the following function:
waiting a predetermined period of time before reusing the unique identification code after the lead request is closed and no longer available before the same unique identification code is assigned to another lead request.

30. The system of claim 1, wherein the machine instructions when executed by the computer further implement the following function:
transmitting a list of one or more responders to the lead requestor, the list including at least a preview of each responder from the list based on the responder information.

31. The system of claim 1, wherein the machine instructions when executed by the computer further implement the following function:
identifying one or more responders from a plurality of responders to offer to the lead requestor as potential leads based at least on the responder information.

32. The system of claim 31, wherein the identifying function includes:
evaluating each responder based on the responder information and criteria defined by the lead requestor; and
identifying the one or more responders from the plurality of responders to offer to the lead requestor as potential leads based on evaluation results.

33. The system of claim 32, wherein the evaluating function includes:
scoring each responder based on the responder information and criteria defined by the lead requestor; and
ranking the plurality of responders based on their respective scores.

34. The system of claim 33, wherein the identifying function includes:
selecting the one or more responders from the plurality of responders to present to the lead requestor based on the ranking.

35. A computer system for qualifying potential leads over an electronic messaging service comprising a computer having non-transitory memory for storing machine instructions that are to be executed by the computer, the machine instructions when executed by the computer implement the following functions:
receiving a call-to-action response via the electronic messaging service from a responder responding to a published advertising unit, the published advertising unit including an advertising message associated with a lead request and a call-to-action message prompting individuals to initiate a computerized screening session in response to the advertising message over the electronic messaging service; and
executing the computerized screening session with the responder over the electronic messaging service in response to the call-to-action response, the computerized screening session based at least in part on a set of pre-screening inquiries selected by a lead requestor to collect responder information.

36. The system of claim 35, wherein the executing function includes:
transmitting at least one inquiry message to the responder over the electronic messaging service; and
receiving an answer message from the responder in reply to the inquiry message over the electronic messaging service.

37. The system of claim 36, wherein the inquiry message is selected from the set of pre-screening inquiries selected with the lead request.

38. The system of claim 36, wherein the executing function further includes:
transmitting a subsequent inquiry message to the responder over the electronic messaging service upon receiving the answer message from the responder; and
receiving a subsequent answer message from the responder in reply to the subsequent inquiry message over the electronic messaging service.

39. The system of claim 38, wherein the subsequent inquiry message is selected from the set of pre-screening inquiries selected with the lead request.

40. The system of claim 36, wherein the inquiry message requires a response from a predetermined range of acceptable responses.

41. The system of claim 40, wherein the machine instructions when executed by the computer further implement the following function:
transmitting a notification message to the responder over the electronic messaging service when the answer message is not within the predetermined range of acceptable responses.

42. The system of claim 36, wherein the machine instructions when executed by the computer further implement the following function:
matching received answer messages with corresponding inquiry messages in a database.

43. The system of claim 42, wherein the machine instructions when executed by the computer further implement the following functions:
tracking a state of progress of the computerized screening session to maintain a proper sequence of inquiries with the responder; and
storing the state of progress in the database when an interruption to the computerized screening session occurs.

44. The system of claim 43, wherein the machine instructions when executed by the computer further implement the following function:
recalling the state of progress of the computerized screening session when the computerized screening session resumes.

45. The system of claim 44, wherein the computerized screening session is resumed upon receiving a resume message from the responder over the electronic messaging service, the resume message including at least a responder identification code and unique identification code associated with the lead request.

46. The system of claim 36, wherein the machine instructions when executed by the computer further implement the following function:
transmitting the at least one inquiry message to the responder in the responder's native language.

47. The system of claim 35, wherein the electronic messaging service is a mobile messaging service.

48. The system of claim 47, wherein the mobile messaging service includes short message service (SMS).

49. The system of claim 47, wherein the mobile messaging service includes an instant messaging (IM) service.

50. The system of claim 35, wherein the electronic messaging service is a web-based messaging service.

51. The system of claim 50, wherein the web-based messaging service includes an instant messaging (IM) service.

52. The system of claim 35, wherein the machine instructions when executed by the computer further implement the following function:
receiving an endorsement of the responder from a third-party over the electronic messaging service.

53. The system of claim 35, wherein the call-to-action message includes a unique identification code associated with the lead request.

54. The system of claim 53, wherein the call-to-action response includes the unique identification code and a responder identification code that uniquely identifies the responder.

55. The system of claim 53, wherein unique identification codes associated with different lead requests are generated in a non-serialized manner in order to reduce the likelihood of initiating wrong computerized screening session due to a typing mistake by the responder.

56. The system of claim 53, wherein the unique identification code is reusable once the associated lead request is closed.

57. The system of claim 56, wherein the machine instructions when executed by the computer further implement the following function:
waiting a predetermined period of time before reusing the unique identification code after the lead request is closed and no longer available before the same unique identification code is assigned to another lead request.

58. The system of claim 35, wherein the machine instructions when executed by the computer further implement the following function:
transmitting a list of one or more responders to the lead requestor, the list including at least a preview of each responder from the list based on the responder information.

59. The system of claim 35, wherein the machine instructions when executed by the computer further implement the following function:
identifying one or more responders from a plurality of responders to offer to the lead requestor as potential leads based at least on the responder information.

60. The system of claim 59, wherein the identifying function includes:
evaluating each responder based on the responder information and criteria defined by the lead requestor; and
identifying the one or more responders from the plurality of responders to offer to the lead requestor as potential leads based on evaluation results.

61. A method for screening responders to a lead request over an electronic messaging service comprising:
receiving a lead request from a lead requestor, the lead request including a description of an advertisement and a selection of a set of pre-screening inquiries;
generating at least one digital interactive advertising unit corresponding to the advertisement based on the lead request, the interactive advertising unit including an advertising message and a call-to-action message prompting individuals to initiate a computerized screening session with the interactive advertising unit in response to the advertising message over an electronic messaging service;
receiving a call-to-action response via the electronic messaging service from a responder responding to the interactive advertising unit;
transmitting at least one inquiry message to the responder over the electronic messaging service, the inquiry message selected from the set of pre-screening inquiries selected with the lead request;
receiving an answer message from the responder in reply to each inquiry message over the electronic messaging service;
collecting responder information from each answer message; and
identifying one or more responders from a plurality of responders to offer to the lead requestor as potential leads based at least on the responder information.

62. The method of claim 61, further comprising:
dividing the inquiry message into parts when the inquiry message exceeds a maximum permissible message length for an electronic messaging protocol associated with the electronic messaging service.

63. The method of claim 61, wherein the inquiry message requires a response from a predetermined range of acceptable responses.

64. The method of claim 63, further comprising:
transmitting a notification message to the responder over the electronic messaging service when the answer message is not within the predetermined range of acceptable responses.

65. The method of claim 64, wherein the notification message includes a prompt to submit a new answer message to the inquiry message.

66. The method of claim 61, further comprising:
matching received answer messages with corresponding inquiry messages in a database.

67. The method of claim 66, further comprising:
tracking a state of progress of the computerized screening session to maintain a proper sequence of inquiries with the responder; and
storing the state of progress in the database when an interruption to the computerized screening session occurs.

68. The method of claim 67, further comprising:
recalling the state of progress of the computerized screening session when the computerized screening session resumes.

69. The method of claim 68, wherein the computerized screening session is resumed upon receiving a resume message from the responder over the electronic messaging service, the resume message including at least a responder identification code and unique identification code associated with the lead request.

70. The method of claim 61, further comprising:
transmitting the at least one inquiry message to the responder in the responder's native language.

71. The method of claim 61, wherein the electronic messaging service is a mobile messaging service.

72. The method of claim 71, wherein the mobile messaging service includes short message service (SMS).

73. The method of claim 71, wherein the mobile messaging service includes an instant messaging (IM) service.

74. The method of claim 61, wherein the electronic messaging service is a web-based messaging service.

75. The method of claim 74, wherein the web-based messaging service includes an instant messaging (IM) service.

76. The method of claim 61, further comprising:
receiving an endorsement of the responder from a third-party over the electronic messaging service.

77. The method of claim 61, wherein the call-to-action message includes a unique identification code associated with the lead request.

78. The method of claim 77, wherein the call-to-action response includes the unique identification code and a responder identification code that uniquely identifies the responder.

79. The method of claim 78, wherein the responder identification code is a caller ID.

80. The method of claim 78, wherein the responder identification code is automatically attached to the call-to-action response as part of an electronic messaging protocol associated with the electronic messaging service.

81. The method of claim 77, wherein unique identification codes associated with different lead requests are generated in a non-serialized manner in order to reduce the likelihood of initiating wrong computerized screening session due to a typing mistake by the responder.

82. The method of claim 77, further comprising:
generating the unique identification code using a random number generator to select a random number between a range of numbers to assign as the unique identification code.

83. The method of claim 82, further comprising:
checking for an active unique identification code associated with another lead request within a predefined threshold around the number selected by the random number generator to minimize potential collisions between nearby numbers.

84. The method of claim 77, wherein the unique identification code is reusable once the associated lead request is closed.

85. The method of claim 84, further comprising:
waiting a predetermined period of time before reusing the unique identification code after the lead request is closed and no longer available before the same unique identification code is assigned to another lead request.
